(19) United States
(12) Patent Application Publication
(10) Pub. No.: US 2009/0140068 A1
(43) Pub. Date: Jun. 4, 2009

(54) Injection Nozzle Having Heating Element And Heat Accumulator And Method For Introducing An Oxidizable Fluid Into An Exhaust System Upstream Of A Catalytic Converter Or Filter

(76) Inventors: Marco Ranalli, Augsburg (DE); Kathrin Bremser, Landsberg (DE)

Correspondence Address: CARLSON, GASKEY & OLDS, P.C., 400 WEST MAPLE ROAD, SUITE 350, BIRMINGHAM, MI, 48009, US

(21) Appl. No.: 12/066,505

(22) PCT Filed: Sep. 6, 2006
(86) PCT No.: PCT/EP2006/008678

§ 371 Date: Jul. 9, 2008

(30) Foreign Application Priority Data
Sep. 20, 2005 (DE) 10 2005 044 780.5

(51) Int. Cl. B05B 1/24; F02M 61/00

(52) U.S. Cl. 239/13; 239/533.12

(57) ABSTRACT

An injection nozzle is used in particular for introducing an oxidizable fluid into an exhaust system upstream of a catalyst or filter. The injection nozzle includes a heating element and a heat accumulator, which can be heated up by the heating element and can dissipate stored heat to the oxidizable fluid. A method for introducing an oxidizable fluid into an exhaust system upstream of a catalyst or filter utilizes the injection nozzle that includes the heating element and a heat accumulator. The heating element is switched on before an injection process, so that the heat accumulator is heated up, and the oxidizable fluid only is injected later, so that the heat accumulator can release energy to the oxidizable fluid and can evaporate the same.

### RELATED APPLICATIONS

The application claims priority to DE 10 2005 044 780.5, which was filed on 20 Sep. 2005.

### BACKGROUND OF THE INVENTION

This invention relates to an injection nozzle usable in particular for introducing an oxidizable fluid into an exhaust system upstream of a catalyst or filter. This invention also relates to a method for introducing an oxidizable fluid into an exhaust system upstream of a catalyst or filter.

Modern exhaust systems frequently include Diesel particulate filters or NOx-storing catalysts. These filters or catalysts must be regenerated in regular intervals, as otherwise their flow resistance will increase excessively or their efficiency will decrease. Regeneration is referred to as “burning-off” because a thermal reaction takes place during the regeneration. This reaction can be initiated by an enriched air/fuel mixture supplied to the internal combustion engine. Alternatively, fuel or some other suitable, oxidizable fluid can be directly introduced into the exhaust system upstream of the filter or catalyst. From the prior art, various systems are known for injecting fuel or also urea into an exhaust pipe.

If the fuel is injected directly, it evaporates in the exhaust pipe. This leads to heat being withdrawn from the exhaust gas stream, which is disadvantageous for the regeneration. For regeneration, an increased exhaust gas temperature is desired. Alternatively, a glow plug might be used, which evaporates the fuel to be injected into the exhaust system outside the exhaust system. It was found out, however, that the power consumption of a glow plug powerful enough for this purpose would lead to an inadmissibly high load acting on the electric system of the motor vehicle.

Thus, it is the object of the invention to create an injection nozzle or a method for injection, which can introduce a necessary amount of fuel or some other suitable fluid into the exhaust system without an undesired decrease in the exhaust gas temperature, and without an excessive load acting on the electric system of the motor vehicle.

### SUMMARY OF THE INVENTION

An injection nozzle, in accordance with the invention, is used to introduce an oxidizable fluid into an exhaust system upstream of a catalyst or filter. The injection nozzle includes a heating element and a heat accumulator, which can be heated by the heating element and can dissipate stored heat to the fluid.

A method for introducing an oxidizable fluid into an exhaust system upstream of a catalyst or filter utilizes this injection nozzle, which includes the heating element and heat accumulator. The heating element is switched on before the injection process so that the heat accumulator is heated up. The fluid only is injected later, so that the heat accumulator can release energy to the fluid and evaporate the fluid.

The invention is based on the fundamental idea of using a heating element with a comparatively low power consumption. The power consumption is so low that the heating element cannot evaporate the fluid to be introduced in the short period of the actual injection process. Instead, the heating element is substantially used for heating up the heat accumulator, so that after a certain “preheating time” a large enough amount of heat is stored, which can then be used to evaporate all of the fluid during the comparatively short injection process.

In one example, a glow plug is used for the heating element. A power consumption in the order of 200 W should be sufficient.

Metal can be used as material for the heat accumulator, for example. A good heat-storage capacity and a particularly high thermal conductivity are important, so that the stored heat can be dissipated to the fluid to be injected within a very short period.

In one example, a gap, through which the fluid can flow, is provided between the heating element and the heat accumulator. This ensures that during the actual injection process, fluid also flows around the heating element such that the fluid can be directly evaporated.

In one example, a housing is provided that accommodates the heat accumulator. An insulating material is arranged between the housing and the heat accumulator. The insulating material prevents heat losses to the outside.

In one example, the heating element is switched on at a predetermined time before the injection process. The heating element remains switched on during injection, and is switched off upon completion of the injection process. The heating element is switched on again in due time before the next injection process.

It should be sufficient to switch on the heating element about 20 seconds before the actual injection process, for example. This period substantially depends on the heating power of the heating element. The lower the heating power, the earlier the heating element must be switched on. The actual injection process takes a time in the order of approximately two to three seconds.

Alternatively, in another example, the heating element remains switched on continuously. The heating power of the heating element then is chosen so low that the heating element can again heat up the heat accumulator to the temperature necessary for evaporating the fluid in the period between two injection processes.

Typically, a period of two to four minutes lies between two successive injection processes.

### BRIEF DESCRIPTION OF THE DRAWINGS

The invention will subsequently be described with reference to an embodiment, which is illustrated in the attached drawings, in which:

FIG. 1 shows a schematic view of a system in accordance with the invention;

FIG. 2 shows a longitudinal section through an injection nozzle in accordance with the invention;

FIG. 3 shows a cross-section through the injection nozzle of FIG. 2 along the plane III-III; and

FIG. 4 shows a diagram in which a heating power P of a heating element, a temperature T of a heat accumulator, and an injected volume V are plotted over time.

### DETAILED DESCRIPTION OF THE PREFERRED EMBODIMENT

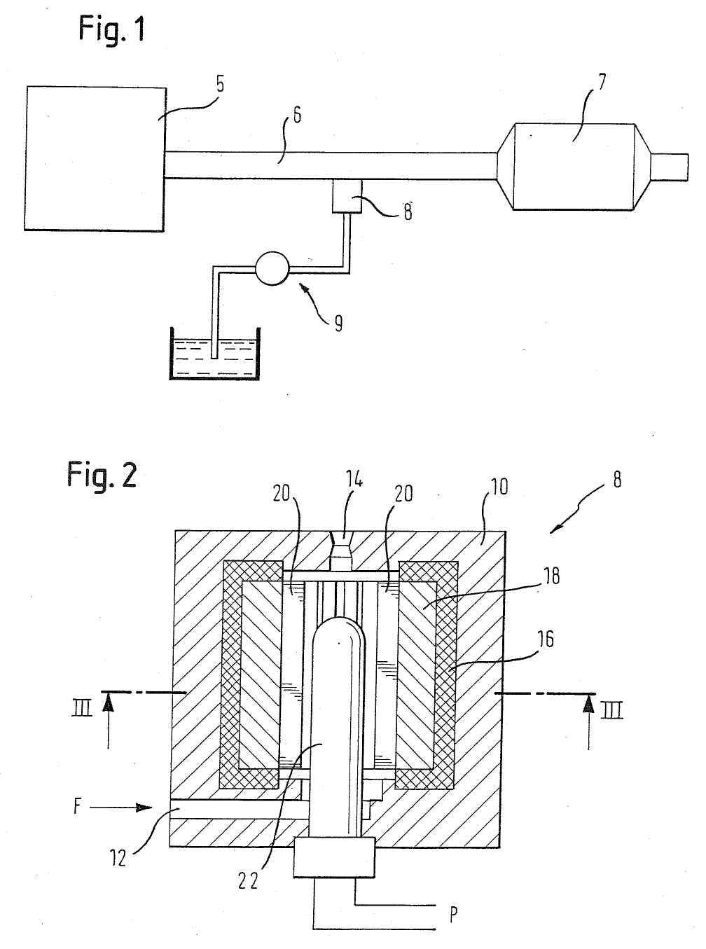

FIG. 1 schematically shows an internal combustion engine 5, in particular a Diesel engine, whose exhaust gases are passed via an exhaust pipe 6 to a catalyst, in particular a NOx-storing catalyst, or a Diesel particulate filter. This component, which reduces the amount of noxious substances in the exhaust gas, here is generally designated with the reference numeral 7. On the exhaust pipe 6, an injection nozzle 8 is mounted, which via a line/pump system 9 can be supplied with an oxidizable fluid, in particular fuel, from a suitable reservoir. The principles of such system are known from the prior art. It generally serves to introduce oxidizable fluid into the exhaust gas stream upstream of the component 7, in order to initiate the regeneration of the component 7.

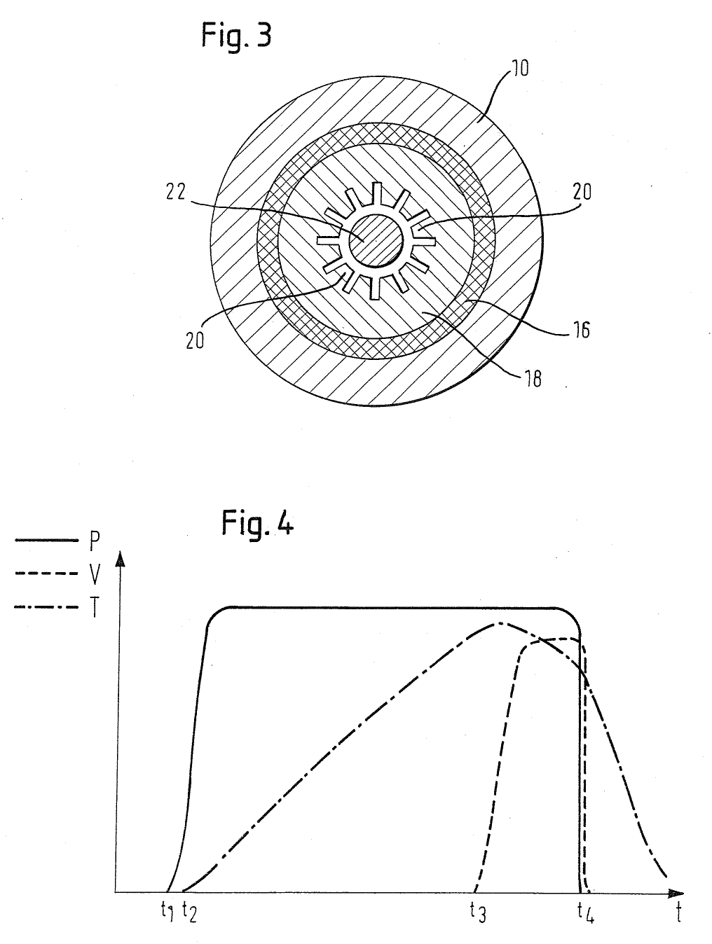

The injection nozzle 8 (see FIGS. 2 and 3) includes a housing 10 that has an inlet 12 for the oxidizable fluid and an outlet 14 for directing the evaporated fluid towards the exhaust system. Inside the housing 10, an insulating material 16 is arranged, which has a low thermal conductivity. Inside the insulating material 16, a heat accumulator 18 is arranged, which is formed of a material with a high thermal capacity and a high thermal conductivity. Most metals can be used for this material. The heat accumulator 18 is generally of annular shape and includes a plurality of ribs 20 that extend towards a central opening. The ribs 20 end at a small distance from a centrally arranged heating element 22, which can be supplied with electric energy P. In one example, a glow plug can be used for the heating element 22. Due to the narrow gap between the heating element 22 and the heat accumulator 18 with the ribs 20, a comparatively large surface is available for heat transfer from the heating element 22 and the heat accumulator 18 to the fluid.

In FIG. 4, it is illustrated how the fluid can be introduced into the exhaust pipe 6 with the injection nozzle 8 as described. The letter P designates the energy supplied to the heating element 22, the letter V designates the volume of the fluid injected through the injection nozzle 8, and the letter T designates the temperature of the heat accumulator 18.

At the time t₁, the heating element 22 is switched on. Shortly afterwards, the temperature of the heat accumulator 18 starts to rise at the time t₂. With a delay in the order of 20 to 30 seconds, the injection process starts at the time t₃. As soon as the oxidizable fluid F is pumped through the gap between the heat accumulator 18 and the heating element 22, the fluid F evaporates as the heat accumulator 18 and the heating element 22 release energy to the fluid. In the process, the temperature of the heat accumulator 18 is decreased. The injection process takes a time in the order of two to three seconds and is completed by the time t₄. At this time, the heating element 22 is switched off.

Alternatively, the heating element can be switched off shortly before the time t₄ and the residual heat can be utilized.

The heating power of the heating element 22, the interval between switching on the heating element 22 and the start of the injection (t₃−t₁), and the thermal capacity in the heat accumulator 18 are dimensioned such that the entire amount of fluid to be injected is evaporated during the injection process.

In this way, it is ensured that heat for evaporating the fluid need not be withdrawn from the exhaust gas stream.

In accordance with an alternative example, it can be provided that the heating element 22 remains switched on continuously. In this case, a very much smaller heating power is required, as between two injection cycles significantly more time is available for heating up the heat accumulator 18.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. An injection nozzle, in particular for introducing an oxidizable fluid into an exhaust system upstream of a catalyst or filter, comprising:
a heating element: and
a heat accumulator that can be heated up by the heating element and can dissipate stored heat to the oxidizable fluid.

2. The injection nozzle according to claim 1, wherein the heating element is a glow plug.

3. The injection nozzle according to claim 1, wherein the heat accumulator is made of metal.

4. The injection nozzle according to claim 1, wherein the heating element is arranged inside the heat accumulator.

5. The injection nozzle according to claim 1, wherein a gap is provided between the heating element and the heat accumulator through which the oxidizable fluid can flow.

6. The injection nozzle according to claim 5, wherein the heat accumulator includes a plurality of ribs that face the heating element.

7. The injection nozzle according to claim 1, including a housing that receives the heat accumulator, and wherein an insulating material is arranged between the housing and the heat accumulator.

8. A method for introducing an oxidizable fluid into an exhaust system upstream of a catalyst or filter, wherein an injection nozzle is used that includes a heating element and a heat accumulator, the method comprising the steps of:
(a) switching on the heating element before an injection process to heat up the heat accumulator; and
(b) subsequently injecting the oxidizable fluid so that the heat accumulator can release energy to the oxidizable fluid and evaporate the oxidizable fluid.

9. The method according to claim 8, including switching on the heating element at a predetermined time before the injection process, leaving the heating element switched on during injection, and switching off the heating element upon completion of the injection process.

10. The method according to claim 8, including switching on the heating element at a predetermined time before the injection process, leaving the heating element switched on during injection, and switching off the heating element shortly before completion of the injection process.

11. The method according to claim 8, including switching on the heating element approximately 20 seconds before the injection process.

12. The method according to claim 8, wherein the heating element remains switched on continuously.

13. The method according to claim 8, wherein the injection process takes a time of approximately two to three seconds.

14. The method according to claim 8, including repeating the injection process after a predetermined time that comprises approximately two to four minutes.
